(19) United States
(12) Patent Application Publication
(10) Pub. No.: US 2010/0296804 A1
(43) Pub. Date: Nov. 25, 2010

(54) FOCUS LENS CONTROL APPARATUS AND IMAGE PICKUP APPARATUS

(75) Inventor: Takahiro Oya, Yokohama-shi (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/776,055

(22) Filed: May 7, 2010

(30) Foreign Application Priority Data
May 19, 2009 (JP) 2009-120647

(51) Int. Cl. G03B 13/36

(52) U.S. Cl. 396/125

(57) ABSTRACT

Provided is a focus lens control apparatus, including: an evaluation signal acquisition unit for acquiring an evaluation signal indicating an in-focus condition from a high frequency component of an acquired image by causing an actuator to drive a focus lens; a detection unit for detecting a driving condition of the actuator; and a drive control unit for performing driving of the focus lens based on the evaluation signal and, after calculating an in-focus position from the evaluation signal, performing the driving of the focus lens under closed-loop control based on an output from the detection unit.

### BACKGROUND OF THE INVENTION

1. Field of the Invention

The present invention relates to a focus lens control apparatus and an image pickup apparatus which perform an in-focus operation by causing an actuator to drive a focus lens.

2. Description of the Related Art

Conventional image pickup apparatuses such as digital cameras often employ an autofocus (hereinafter, referred to as “AF”) method called “TV-AF (so-called contrast detecting) method” (see, for example, Japanese Patent Application Laid-Open No. 2004-102135). In this method, a subject distance is calculated from a peak position of a contrast-method AF evaluation signal in each point obtained by causing a focus lens to scan a predetermined range. Then, the focus lens is driven so as to achieve an in-focus condition according to the obtained subject distance, to thereby perform an in-focus operation. In this case, as in the known technology, the larger value of the AF evaluation signal indicates that a subject is in sharper focus.

However, the following problem as described with reference to FIGS. 7, 8A, and 8B exists in the above-mentioned conventional example, in which the focus lens is driven under open-loop control. FIG. 7 is a diagram illustrating a relationship among a peak position P, a depth of field, and a focus lens stop position. FIGS. 8A and 8B are diagrams illustrating a driving pattern and an electrical angle, respectively, obtained when a stepping motor (hereinafter, referred to as “STM”) for driving the focus lens is driven by 1-2-phase excitation. FIGS. 8A and 8B illustrate a case where there is cogging at a 1-phase excitation position.

A stop resolution of the focus lens is decided based on a rotation amount of the STM for 1 step of the driving pattern and a lead of a lead screw provided integrally to an output shaft of the STM. Accordingly, even if the STM is driven so as to cause the focus lens to stop at the peak position P, in actuality, the focus lens is caused to stop at a position p nearest to the peak position P (in this case, at the position 1 in terms of the electrical angle as illustrated in FIG. 7). Still, there has been no problem as long as the position p falls within the depth of field as illustrated in FIG. 7.

However, in recent years, a pixel count of an image pickup element is becoming higher, and the depth of field is becoming narrower accordingly. There is a fear that the conventional stop resolution may inhibit the focus lens from stopping within the depth of field.

In order to solve the problem, the stop resolution needs to be set finer. One of the possible solutions is to shorten the lead of the lead screw. However, in this case, a feed per step of the focus lens is reduced, and hence a driving speed in normal drive such as rough alignment for acquiring the AF evaluation signal may be decreased. Another possible solution is to drive the STM in micro-step phase excitation to cause the STM to stop more minutely so as to drive the focus lens to the peak position P existing between the electrical angle 1 and an electrical angle 2. However, even in this case, in actuality, the stopping in micro-step phase may not be caused due to attraction from a cogging position in an A+phase, because the diameter of the STM is reduced to be smaller along with a trend toward downsizing of a camera.

### SUMMARY OF THE INVENTION

The present invention has been made in view of the above-mentioned problem, and an object of the present invention is to provide an autofocus apparatus and an image pickup apparatus which are capable of achieving higher precision of autofocus.

A focus lens control apparatus according to an aspect of the present invention, includes: an evaluation signal acquisition unit for acquiring an evaluation signal indicating an in-focus condition from a high frequency component of an acquired image by causing an actuator to drive a focus lens; a detection unit for detecting a driving condition of the actuator; and a drive control unit for performing driving of the focus lens based on the evaluation signal and, after calculating an in-focus position from the evaluation signal, performing the driving of the focus lens under closed-loop control based on an output from the detection unit.

Further features of the present invention will become apparent from the following description of exemplary embodiments with reference to the attached drawings.

### BRIEF DESCRIPTION OF THE DRAWINGS

FIG. 1 is a structural diagram illustrating an autofocus apparatus according to an embodiment of the present invention.

FIG. 2 is a graph illustrating a relationship between a torque and a rotation number observed in the STM according to the embodiment.

FIG. 3 is a diagram illustrating a relationship between cogging and a current ratio observed in the STM according to the embodiment.

FIG. 4 is a flowchart illustrating an operation according to the embodiment.

FIG. 5 is a graph illustrating a relationship between an AF evaluation signal and a subject distance in a scan under rough alignment (hereinafter, referred to as “rough-alignment scan”).

FIG. 6 is a graph illustrating a relationship between the AF evaluation signal and the subject distance in a fine scan under rough alignment (hereinafter, referred to as “rough-alignment fine scan”).

FIG. 7 is a graph illustrating a relationship between a depth of field and a focus lens stop position.

FIGS. 8A and 8B are diagrams illustrating a driving pattern and an electrical angle, respectively, obtained when the STM is driven in 1-2-phase excitation.

### DESCRIPTION OF THE EMBODIMENTS

Hereinafter, description is made of an exemplary embodiment for implementing the present invention.

### Embodiment

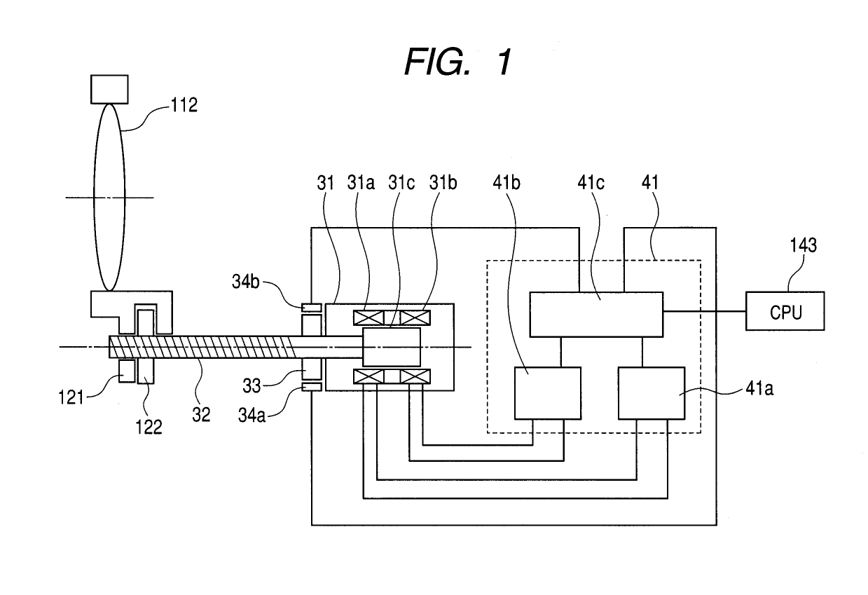

FIG. 1 is a structural diagram illustrating an autofocus apparatus included in an image pickup apparatus according to an embodiment of the present invention.

In FIG. 1, the autofocus apparatus includes a focus lens 112, a lens-holding frame 121, and a nut member 122 that advances/retreats integrally with the lens-holding frame 121. A stepping motor (STM) 31 is used for driving the focus lens 112, and includes a 2-phase excitation coil formed by an A-phase stator 31a and a B-phase stator 31b, a rotor 31c, and a lead screw 32 that is connected directly to the rotor 31c and caused to rotate integrally therewith. An encoder magnet 33 is attached integrally to the lead screw 32, and polarized to exhibit a plurality of magnetic poles in order to detect a rotation phase of the STM 31. The rotation phase is detected by two Hall elements 34a and 34b.

A drive control unit 41 performs control to drive the STM 31, and includes an A-phase driver 41a for applying a current to the A-phase stator 31a, a B-phase driver 41b for applying a current to the B-phase stator 31b, and a control unit 41c for driving those drivers. The control unit 41c receives an input of a driving amount and a driving direction of a focus lens from a CPU 143 and an input of rotation phase information on the STM 31 from the two Hall elements 34a and 34b, and performs control of the A-phase driver 41a and the B-phase driver 41b based on the input information.

As described above, in addition to the driving information input from the CPU 143, the control unit 41c constantly receives the input of the rotation phase information on the STM 31 detected by the two Hall elements 34a and 34b. The control unit 41c controls the A-phase driver 41a and the B-phase driver 41b based on the rotation phase information so as to apply a current to the A-phase stator 31a and the B-phase stator 31b, respectively, to thereby drive the STM 31.

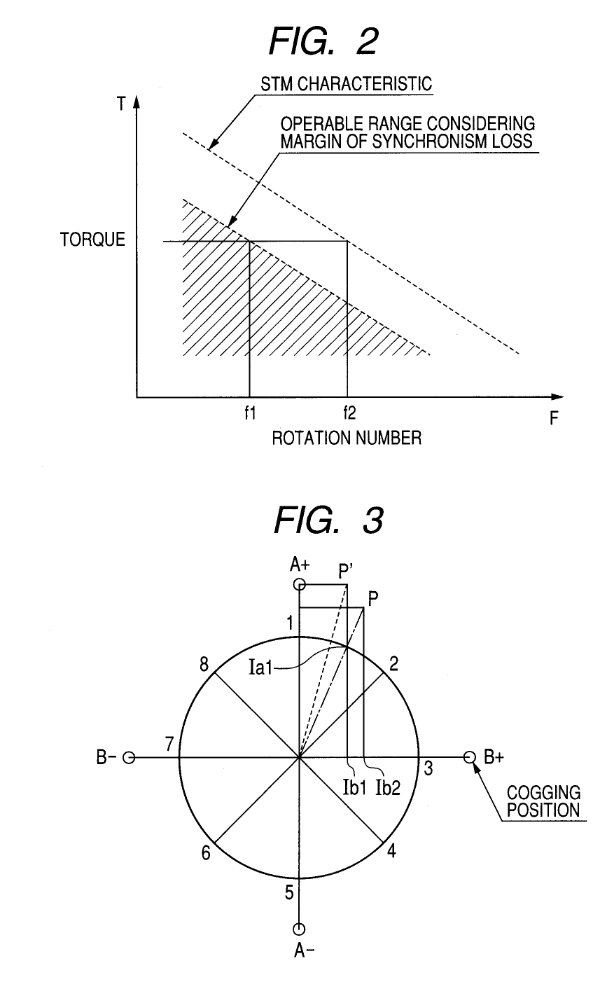

FIG. 2 is a T-F curve representing a general relationship between a torque T (ordinate) and a rotation number F (abscissa) observed in the STM 31.

In general, a synchronism loss in which an STM fails to rotate in response to an input occurs if the STM is applied with a torque load equal to or larger than its ability at a given rotation number. Therefore, in the conventional example in which the STM is driven under open-loop control, the STM needs to be driven at a rotation number f1 within a range considering a margin of synchronism loss with respect to characteristics of the STM.

On the other hand, in this embodiment, the STM may be driven at a rotation number f2 near a synchronism loss limit based on the rotation phase information on the STM 31 detected by the two Hall elements 34a and 34b. Accordingly, the STM 31 may be driven at speed higher than the conventional example and may be caused to stop at higher precision.

FIG. 3 is a diagram illustrating a relationship between cogging and a current ratio observed in high precision driving.

FIG. 3 assumes a case where a current is supplied to the A-phase stator 31a and the B-phase stator 31b at a current ratio of Ia1:Ib1 in order to cause the focus lens 112 to stop at a peak position P. In this case, in the conventional example, the peak position P is caused to revolve toward an electrical angle 1 and stop at a position P′ due to attraction by a cogging torque in an A+phase.

In contrast, in this embodiment, the rotation phase information on the output shaft of the STM 31 is constantly detected by the Hall elements 34a and 34b. Therefore, the current to be caused to flow to the B-phase stator 31b may be changed so as to correct a difference between a stop position P being a target position according to the driving information input from the CPU 143 and output information on an actual stop position P′. As the current to be caused to flow to the B-phase stator 31b is thus increased, the peak position P is caused to revolve toward an electrical angle 2, and the cogging torque in the A+phase decreases accordingly. Then, the current applied to the B-phase stator 31b is increased up to Ib2 illustrated in FIG. 3, to thereby cause the focus lens 112 to stop at the peak position P being the target position.

Therefore, even if a depth of field becomes narrower along with an increased pixel count of an image pickup element in recent years, in other words, even if the depth of field becomes narrower than an amount in which the STM 31 moves by one electrical angle step, the focus lens 112 may be caused to stop within the depth of field. In addition, under such high precision drive control, the focus lens 112 may be caused to stop at any position irrespective of a cogging position of the STM 31. Therefore, an STM having a smaller diameter may also be driven in a micro-step phase, and may also be used for enhancing a stop resolution of the focus lens 112 in micro-step phase drive, in comparison with 1-2-phase drive.

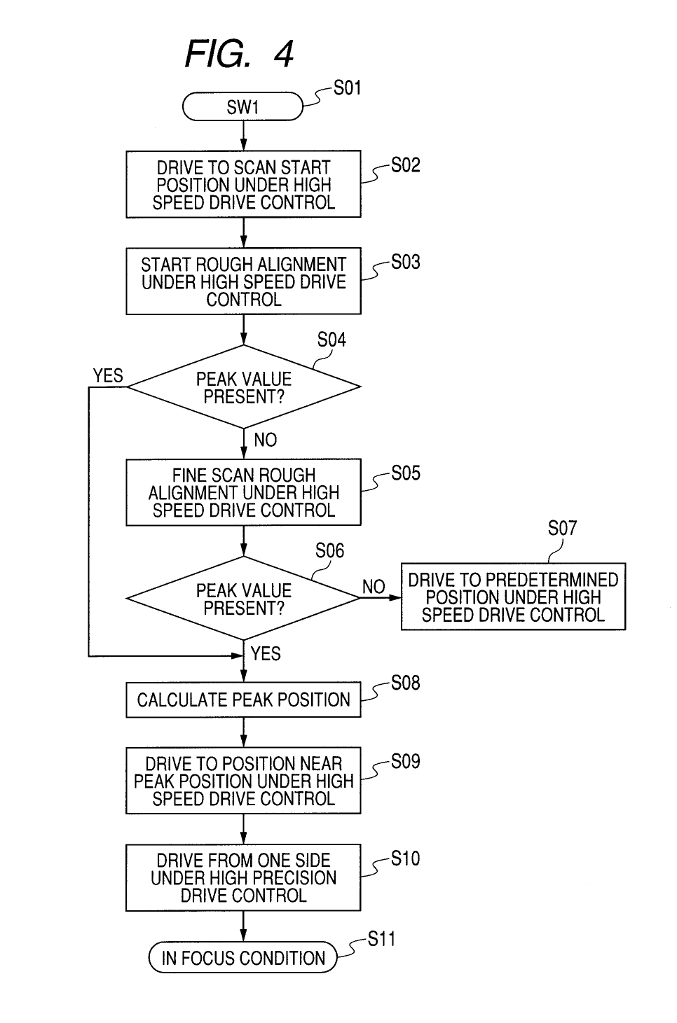

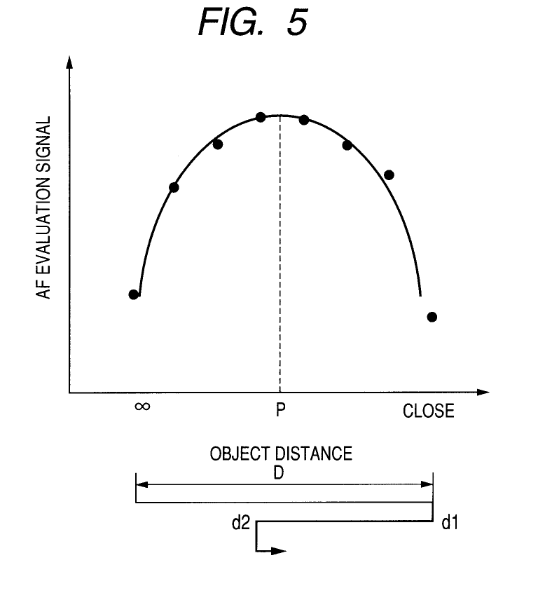

Next, a series of processing in an in-focus operation according to this embodiment is described with reference to a flowchart of FIG. 4. In Step S01, a release switch of a camera is touched and the CPU 143 detects that a switch SW1 is turned on. Then, the CPU 143 starts an operation of Step S02 and the subsequent steps. First, in Step S02, the focus lens 112 is caused to move to a position focused on an infinite distance, which is a scan start position, at the rotation number f2 (f1<f2) of FIG. 2 under high speed drive control and closed-loop control. In next Step S03, a rough alignment is started under high speed control at the rotation number f2 shown in FIG. 2 and closed-loop control. In the rough alignment, the focus lens 112 is caused to move (or scan) in a stroke D or a predetermined range from in-focus position for infinite end to in-focus position for closed end, as shown in FIG. 5, and AF evaluation signals are acquired in the stroke D at a predetermined interval shown by the black dots. The position dl represents an rough alignment complete position.

Subsequently in Step S04, it is determined whether or not a peak value is present, based on AF evaluation signals obtained in Step S03. Whether or not a peak value is present is determined based on whether or not the AF evaluation signals are equal to or higher than a given threshold value or whether or not the AF evaluation signals exhibits a mountain shape with a subject distance as the abscissa and the AF evaluation signal as the ordinate. FIG. 5 illustrates a relationship between the AF evaluation signal and the subject distance in a case where it is determined that a peak value is present. If a peak value is present, the processing advances to Step S08 described later, and if it is determined that a peak value is not present, the processing advances to Step S05.

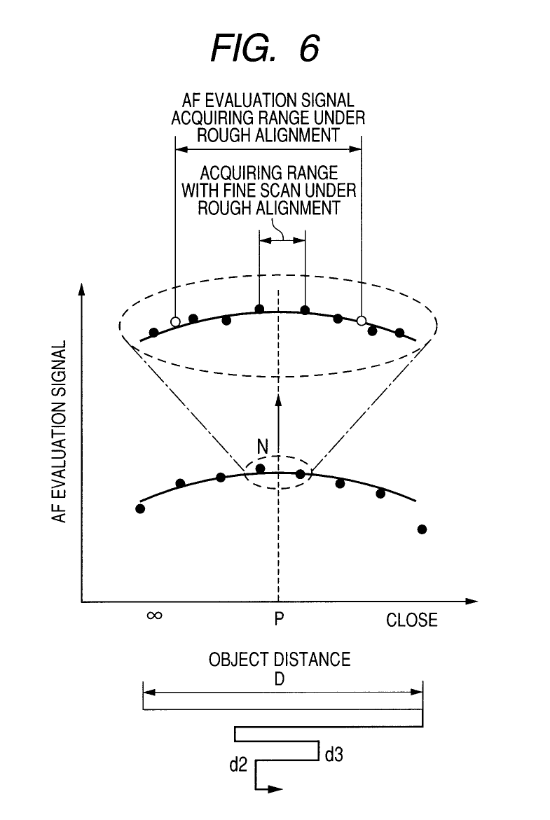

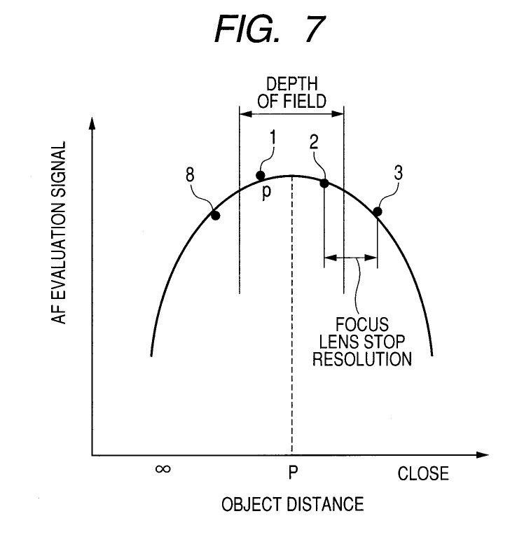

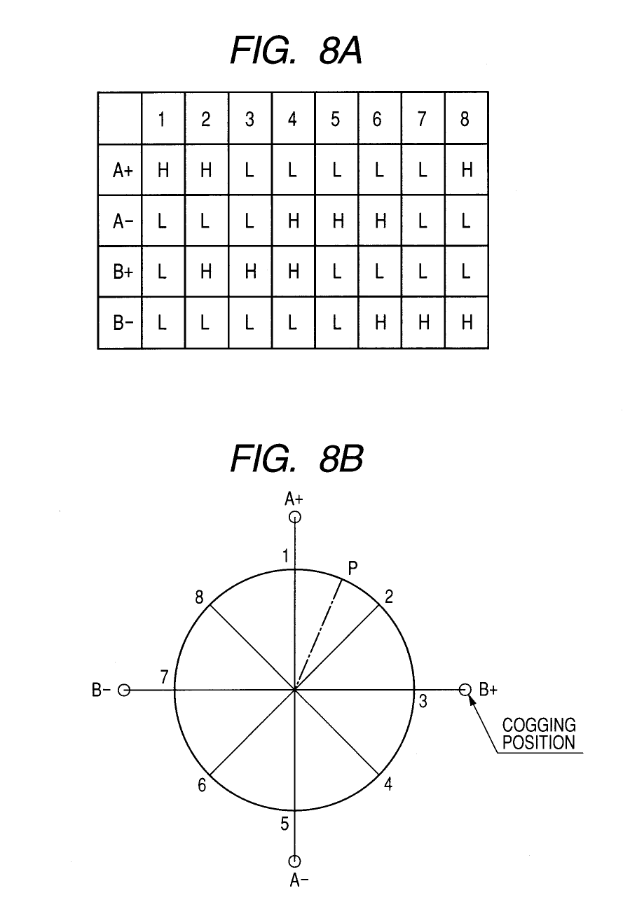

When the processing advances Step S05, a rough-alignment fine scan is performed under high speed drive control and closed-loop control. FIG. 6 illustrates a relationship between the AF evaluation signal and the subject distance in a case where it is determined that a peak value is not present under rough alignment. In FIG. 6, the mountain shape obtained by the AF evaluation signals from the infinite distance to a close range is ambiguous. In the rough-alignment fine scan, the focus lens 112 is driven to an area N surrounded by the dotted line which is determined as being near the peak of the mountain shape under rough alignment, and AF evaluation signals are again acquired within a range narrower than the range under the rough alignment. At this time, a predetermined interval for acquiring the AF evaluation signals is shortened in comparison with the interval under the rough alignment, to thereby increase precision in determining the peak.

Subsequently in Step S06, it is determined whether or not a peak value is present, based on the AF evaluation signals obtained again in Step S05. If it is determined that a peak value is not present even in the rough-alignment fine scan, the processing advances to Step S07, and the focus lens 112 is driven to a predetermined point under high speed drive control and closed-loop control. The predetermined point represents a preset position such as a hyperfocal distance.

Meanwhile, if it is determined that a peak value is present in the rough-alignment fine scan, the procedure advances from Step S06 to Step S08, in which the peak position P is calculated. Subsequently in Step S09, fine alignment is started. Specifically, the focus lens 112 is driven during a stroke from a rough-alignment end position d1 to a position d2 near the peak position P of FIG. 5 (from a rough-alignment fine scan end position d3 to the position d2 of FIG. 6), under high speed drive control and closed-loop control. The high speed drive control represents closed-loop control for increasing the speed, under which the focus lens 112 is caused to move in the 1-2-phase drive (which may be 2-2-phase drive or micro-step drive) at a speed f2, which is higher than a speed f1 of the conventional movement with consideration given to the margin of synchronism loss. Subsequently in Step S10, the focus lens 112 is driven from one side under the high precision drive control and closed-loop control, to thereby be caused to move to the peak position P. In Step S11, the in-focus operation is completed. The high precision drive control represents closed-loop control for increasing the stop resolution, under which the focus lens 112 is caused to stop at a position determined more finely than in the 1-2-phase drive.

The above-mentioned embodiment is configured so that a driving condition of the STM 31 is detected by the encoder magnet 33 and the two Hall elements 34a and 34b, and that, based on the detection results, in-focus drive is performed by closed loop under high speed drive control near the synchronism loss limit. This enables higher speed of AF. Further, in the fine alignment for driving the focus lens to an in-focus position calculated based on an evaluation signal, the closed-loop control is performed so as to enhance the stop resolution of the focus lens 112, to thereby realize higher precision of AF in an autofocus method called “TV-AF method”.

Note that a scan operation for acquiring the AF evaluation signal may be performed under open-loop control as in the conventional example.

### Correspondences Between the Present Invention and the Exemplary Embodiment

The focus lens 112 corresponds to a focus lens according to the present invention, and the STM 31 corresponds to an actuator for driving the focus lens 112 according to the present invention. Further, a part of the CPU 143 for performing the operation of Steps S03 to S06 and S08 corresponds to an evaluation signal acquisition unit for acquiring the evaluation signal indicating an in-focus condition by causing the focus lens 112 to scan a predetermined range according to the present invention. Further, the encoder magnet 33 and the Hall elements 34a and 34b correspond to a detection unit for detecting the driving condition of the actuator according to the present invention. Further, a part of the CPU 143 for performing the operation of Steps S09 and S10 corresponds to a drive control unit for performing the in-focus drive on the focus lens 112 under closed-loop control based on an output from a detection unit according to the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-120647, filed May 19, 2009, which is hereby incorporated by reference herein in its entirety.

What is claimed is:

1. A focus lens control apparatus, comprising:
an evaluation signal acquisition unit for acquiring an evaluation signal indicating an in-focus condition from a high frequency component of an acquired image by causing an actuator to drive a focus lens;
a detection unit for detecting a driving condition of the actuator; and
a drive control unit for performing driving of the focus lens based on the evaluation signal and, after calculating an in-focus position from the evaluation signal, performing the driving of the focus lens under closed-loop control based on an output from the detection unit.

2. A focus lens control apparatus according to claim 1 wherein the detection unit detects the driving condition of the actuator by using an encoder provided to an output shaft of the actuator.

3. A focus lens control apparatus according to claim 1 wherein the actuator comprises a stepping motor and enhances a stop resolution of the focus lens by constantly detecting the driving condition of the stepping motor and causing the focus lens to stop at intervals smaller than one electrical angle step.

4. An image pickup apparatus, comprising the focus lens control apparatus according to claim 1.
